(19) United States
(12) Patent Application Publication
(10) Pub. No.: US 2018/0103592 A1
(43) Pub. Date: Apr. 19, 2018

(54) Attachment device for suction apparatus

(71) Applicant: Rand Corrie, Orlando, FL (US)

(72) Inventor: Rand Corrie, Orlando, FL (US)

(21) Appl. No.: 15/293,424

(22) Filed: Oct. 14, 2016

(51) Int. Cl. A01G 1/12; A47L 9/02; A47L 9/00

(52) U.S. Cl. CPC A01G 1/125; A47L 9/009; A47L 9/02

(57) ABSTRACT

Attachment devices that enhance at least one of the functions provided by a suction apparatus are disclosed. In an aspect, attachment devices for suction apparatus are disclosed that comprise at least one rolling component. Such attachment devices may be removably attached to an inlet opening associated with a suction apparatus so as to allow the inlet opening to be slid by a user upon a surface with minimal effort while substantially maintaining or improving the amount of suction provided by the suction apparatus at the opening of an intake cavity associated with a given attachment device. Providing a relatively high amount of suction at the opening of the intake cavity may facilitate the intake of relatively larger and/or heavier objects into the suction apparatus, such as, for example, oak leaves.

### FIELD

The present disclosure generally relates to suction apparatus, and more particularly to attachment devices for enhancing one or more capabilities of suction apparatus by increasing at least one aspect of the functionality of such suction apparatus.

### BACKGROUND

The statements in this section merely provide background information related to the present disclosure and may not constitute prior art.

For many individuals, land and/or home ownership is a desirable achievement. Owning land provides, among other things, financial security in the form of a stable investment, a higher degree of social status, and personal pride. Although land ownership is generally regarded as a good thing, it takes a considerable amount of effort and/or money in order to maintain the land and keep it aesthetically pleasing. Aesthetics become more important when a home is placed upon the land, where factors such as “curb appeal” motivate homeowners to go the extra mile to make sure the outside of their homes and associated yards look clean and well maintained, lest the homeowners be labeled as “lazy” or “sloppy.”

In order to capitalize on the desire of land and/or home owners to keep their land, particularly, yards/lawns and landscapes, looking neat and tidy, many companies have produced products that assist individuals in maintaining their land. For example, various lawn mowers, trimmers, lawn edgers, chainsaws, wood chippers, leaf blowers, rakes, yard vacuums, and lawn mower baggers have all been provided in an effort to help land owners keep their property looking good.

Perhaps one of the most frustrating property maintenance activities is the removal of leaves and/or other debris. Depending on one's geographical location and the time of year, leaves/debris may accumulate in varying quantities on the ground for various periods of time (sometimes all year long). However, no matter what the quantity of leaves/debris is, removing them is inconvenient at best and at worst can be a task that requires an entire day, if not more.

Several tools have been developed in an effort to make leaf/debris removal easier. Perhaps the most basic of these tools is the rake. Rakes have been used for decades to groom yards and while they are helpful, they are very cumbersome and time consuming to use. Anyone who has ever had to rake even a moderately sized lawn in the fall knows what a laborious task it can be, only to have the lawn re-covered with newly fallen leaves within a few days, if not a few hours. The chore can seem never-ending and takes up valuable time that could be spent on other activities. Plus, once the leaves/debris have been raked, they then have to be bagged in order to prevent them from being redistributed about the lawn, which only adds to the time-consuming nature of the process.

As an alternative to raking, many people use leaf blowers to facilitate the leaf/debris removal process. While leaf blowers are less labor intensive than raking, leaf blowers are usually heavy and/or bulky to carry around. Additionally, it may be difficult to control where targeted leaves/debris get blown, especially on windy days, and bagging the leaves/debris is still required at the end of the process.

Individuals who opt to rake their leaves/debris and/or use leaf blowers face the potential of being exposed to allergy triggers, such as dust and/or pollen. Raking and/or blowing leaves/debris inherently causes dust, pollen, and/or other allergens that may be residing on them to move about and potentially become airborne, increasing the likelihood of the allergens coming into direct and/or close contact with the person engaging in leaf/debris removal. In order to avoid the allergens associated with leaves and other types of lawn debris, allergic individuals often wear uncomfortable facemasks, or avoid the task altogether.

The development of the lawn vacuum has helped to curtail some of the frustrations that people experience due to raking and leaf blowing. A common lawn vacuum is a portable vacuum configured for outdoor use (such as a Shop-Vac®, available from the Shop-Vac Corporation of Williamsport, Pa.) and often comprises an inlet opening such as a nozzle at the end of a hose. The hose leads to a reservoir where lawn debris, such as leaves, gets deposited. Lawn vacuums facilitate leaf/debris removal from land by using suction to pick up the leaves/debris and then deposit them into the reservoir, thereby eliminating at least some of the tediousness of raking and using a leaf blower by eliminating the bagging step and by eliminating the need to push the leaves/debris around the land. However, although lawn vacuums add a degree of efficiency to the leaf/debris removal process, they are still rather cumbersome to use in that they are often bulky and/or heavy to move around. Additionally, the inlet opening is very limited in efficiency in that users must aim the opening directly at the particular leaf(ves) or debris to be picked up while maintaining the inlet opening at a height the prevents the suction provided by the vacuum from “locking” the opening to the ground. A considerable amount of effort is needed in order to break this suction induced locking force and may be a particularly difficult task for younger children, the elderly, and those with one or more physical handicaps. Furthermore, while the potential of exposure to allergens may be reduced, it is still relatively high in that the inlet opening may move leaves and other types of lawn debris around without sucking them in right away due in part to erratic or inconsistent movements made by the user.

In order to supplement lawn vacuum usage, some attachment devices have been developed to make the vacuums more efficient and easier to maneuver. For example, attachments with wheels on them have been created that fit onto the end of a lawn vacuum inlet opening in order to allow a user to move the opening more easily without having to carry it all the time. Such attachment devices also maintain the inlet opening at a relatively consistent height above the ground in order to facilitate a uniform amount of vacuum coverage. However, despite their advantages, these attachment devices are not designed to provide enough suction power to pick up more than relatively light and/or small objects. This becomes a problem when trying to remove larger and/or heavier objects from land, such as oak leaves. Additionally, the attachment devices that have been developed are more complex than necessary in that they comprise several different pieces and/or components that are assembled together, thereby increasing the likelihood of breakage and/or user installation error, as well as increasing the overall weight of the devices unnecessarily, making them needlessly more difficult to use.

Given the foregoing, attachment devices are needed that facilitate the ability of a user to use a suction apparatus with less effort. Additionally, attachment devices are needed that allow a user to use such suction apparatus while minimizing the user's exposure to allergens. Attachment devices that maintain a high level of suction power for the suction apparatus are also desired, as are attachment devices that comprise a minimal number of components.

### SUMMARY OF THE INVENTION

This Summary is provided to introduce a selection of concepts. These concepts are further described below in the Detailed Description section. This Summary is not intended to identify key features or essential features of this disclosure's subject matter, nor is this Summary intended as an aid in determining the scope of the disclosed subject matter.

Aspects of the present disclosure provide attachment devices for suction apparatus configured to allow a user of a suction apparatus to move an inlet opening associated with the suction apparatus with relatively little effort. Specifically, in an aspect, attachment devices are disclosed that fit securely to the distal end of a variety suction apparatus inlet openings, such as a nozzle, wherein such attachment devices comprise at least one wheel or similar rolling component so as to allow the attachment device to be pushed along a surface, such as a lawn, while experiencing minimal resistance.

In an aspect, the at least one wheel associated with the attachment devices of the present disclosure is configured to move across an outdoor terrain, such as grass. The at least one wheel may help keep an attachment device at a relatively consistent height during use, thereby preventing it from making complete, direct contact with the ground and becoming “locked” to the ground due to the suction force provided by the suction apparatus. Additionally, the at least one wheel may be configured to maintain the attachment device at a height such that a maximum amount of suction is applied to objects to be picked up while a minimal amount of object, debris, and/or allergens are allowed to escape out of the sides of the attachment device.

In some aspects, attachment devices of the present disclosure may be configured to facilitate the intake of relatively large and/or heavy objects into a suction apparatus. For example, leaves, particularly oak leaves, are often too big and/or heavy to be received by currently available yard vacuum attachments. The attachment devices of the present disclosure may comprise a body component with an inlet opening of such size, proportions, and configuration so as to allow for a high suction force to be transferred from the standard inlet opening of a given suction apparatus to the attachment device. This may be achieved, for example, by making a cross section of an intake opening of the attachment device smaller than the inlet opening of the suction apparatus, thereby creating a difference in air pressure that causes air to move from a relatively high pressure state within the intake opening of the attachment device (where it is relatively compressed) to a relatively low pressure state within the inlet opening of the suction apparatus (where it is allowed to expand). This air flow enhances the suction flow already provided by the suction apparatus.

In some additional aspects, attachment devices in accordance with the present disclosure may comprise a relatively small number of parts/components, thereby making the attachment devices durable, resistant to breakage, and relatively lightweight (and therefore easier and/or more efficient to use). Additionally, by comprising only a few parts, the attachment devices of the present disclosure are also relatively easy to use and install. The attachment devices may be configured to fit securely onto a wide variety of suction apparatus nozzle intake opening shapes and sizes, and, in some aspects, the attachment devices may comprise parts that are already readily available.

Further features and advantages of the present disclosure, as well as the structure and operation of various aspects of the present disclosure, are described in detail below with reference to the accompanying drawings.

### BRIEF DESCRIPTION OF THE DRAWINGS

The features and advantages of the present disclosure will become more apparent from the Detailed Description set forth below when taken in conjunction with the drawings in which like reference numbers indicate identical or functionally similar elements.

FIG. 1 is a front view of an exemplary attachment device for use with an exemplary suction apparatus, according to an aspect of the present disclosure.

FIG. 2 is a rear view of an exemplary attachment device for use with an exemplary suction apparatus, according to an aspect of the present disclosure.

FIG. 3 is a perspective view of an exemplary suction apparatus usable with an exemplary attachment device, according to an aspect of the present disclosure.

### DETAILED DESCRIPTION

The present disclosure is directed to attachment devices that serve to enhance various functional aspects of different kinds of suction apparatus. Aspects of the present disclosure provide attachment devices that make various types of suction apparatus easier to use and/or more efficient in use. Specifically, in an aspect, attachment devices for suction apparatus are disclosed that are configured to removably or permanently attach to the inlet openings associated with various types of suction apparatus, wherein such attachment devices include at least one wheel, caster, or similar rolling component configured to facilitate movement of the attachment devices across both indoor and outdoor surfaces to be cleaned. In some aspects, attachment devices in accordance with the present disclosure may be configured to substantially maintain or increase the amount of suction provided by the suction apparatus to which they are attached. In some additional aspects, attachment devices are disclosed that are comprised of relatively view components in order to prevent breakage, increase their ease of use and/or installation, and/or maintain a relatively lightweight configuration in order to facilitate an increase in ease, efficiency, and/or speed of use.

The term “suction apparatus” and/or the plural form of this term are used throughout herein to refer to any apparatus capable of providing a suction and/or blowing force powerful enough to take in or push at least one type of object, such as indoor and/or outdoor vacuums, industrial vacuums, shop vacuums (such as Shop-Vacs® available from the Shop-Vac Corporation of Williamsport, Pa.), lawn vacuums, yard vacuums, leaf vacuums, leaf blowers, air blowers, and the like.

The term “attachment device” and/or the plural form of this term are used throughout herein to refer to any device or mechanism capable of being removably or permanently received by the inlet opening of a suction apparatus as defined above, such as brushes, wands, nozzles, gulfers, and the like.

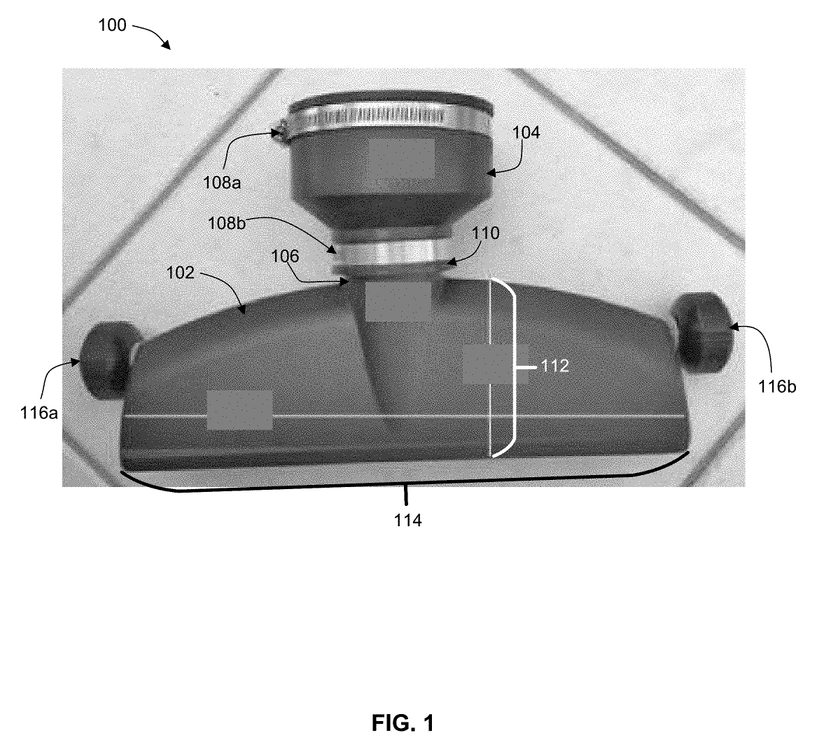

Referring now to FIG. 1, a front view of an exemplary attachment device 100 for use with an exemplary suction apparatus 300, (not shown in FIG. 1), according to an aspect of the present disclosure, is shown.

In an aspect, attachment device 100 may comprise a body 102, at least one attachment element 104, at least one intake opening 106, at least one fastening element 108 (shown as fastening elements 108a-b in FIG. 1), and at least one connector portion 110.

Body 102 comprises a depth 112 and a width 114. In some aspects, body 102 may be removably or permanently attachable to an attachment element 104 when a connector portion 110 associated with attachment element 104 fits upon intake opening 106 of body 102. At least one fastening element 108 may serve to keep intake opening 106 securely attached within connector portion 110. By way of example and not limitation, fastening element 108 may comprise one or more clamps, clips, pins, bolts, nuts, screws, nails, cable ties, hook-and-loop fasteners, adhesives, rivets, and/or clasps, as well as any similar elements as may be apparent to those skilled in the relevant art(s) after reading the description herein. Connector portion 110 may be formed as a portion of attachment element 104 itself, or connector portion 110 may be removably or permanently attached to attachment element 104. In some additional aspects, attachment element 104 is formed as a part of body 102. In such aspects, connector portion 110 and the corresponding fastening element(s) 108 (fastening element 108b in FIG. 1) are not needed.

Attachment element 104 may be configured to be removably or permanently attached to the inlet opening of at least one type of suction apparatus, such as, by way of example and not limitation, exemplary suction apparatus 300. Attachment element 104 may be held securely in place upon the inlet opening via one or more fastening element(s) 108. By way of example and not limitation, attachment element 104 may be configured to removably or permanently attach to an inlet opening in the form of the open end of a nozzle 306 (not shown in FIG. 1) of suction apparatus 300. In such an exemplary embodiment, fastening element 108 that secures attachment element 104 to the end of nozzle 306 may comprise, without limitation, at least one metal clamp, as well as any of the other types of fastening elements 108 previously listed. Attachment element 104 may be configured to fit upon (or, in some aspects, within) various shapes and/or sizes of inlet openings associated with various different forms of suction apparatus 300.

In some aspects, body 102 may be integrated with at least one rolling component 116 (shown as rolling components 116a-b in FIG. 1). By way of example and not limitation, rolling components 116 may comprise one or more wheels, casters, rolling cylinders, rolling balls, axles 210 (not shown in FIG. 1), retaining channels 212 (not shown in FIG. 1) for axles 210, as well as any similar components as may be apparent to those skilled in the relevant art(s) after reading the description herein.

Rolling components 116 may facilitate the ease of use of attachment device 100 and any type of suction apparatus 300, generally, to which attachment device 100 may be connected to by allowing a user to slide an inlet opening, such as nozzle 306, associated with suction apparatus 300 across a surface rather than carry it around. This helps shift the user's center of gravity during use of suction apparatus 300, thereby causing less strain on the user's body, especially the user's back and arms. Additionally, rolling components 116 may serve to keep an intake cavity 202 (not shown in FIG. 1) and an opening associated therewith of body 102 at a consistent height above a surface, thereby helping to maintain a consistent amount of suction force (or blowing force) applied to the surface, as well as helping to prevent situations wherein the opening of intake cavity 202 gets too close to the surface and causes attachment device 100 and its associated inlet opening to become “locked” to the surface due to the suction force provided by suction apparatus 300 holding the opening of intake cavity 202 tightly against the surface. Preventing these types of situations may be important, for example, in that it may be difficult for some users to provide enough pulling force to separate a “locked” attachment device 100 from a surface.

In some aspects, rolling components 116 (as well as suction apparatus 300, generally) may be configured for indoor surfaces (such as hardwood floors, tile floors, carpet, linoleum, and the like), outdoor surfaces (such as grass, dirt, concrete, tar, gravel, rocks, rough terrain, sand, mud, and the like), or both. By way of example and not limitation, rolling components 116 that are configured for indoor surfaces may comprise relatively small, plastic or metal wheels while rolling elements 116 that are configured for outdoor surfaces may comprise relatively large wheels with rubber tires that include treads. In any instance, rolling components 116 may be configured in any appropriate location as may be apparent to those skilled in the relevant art(s) after reading the description herein, including upon one or more side portion(s) of attachment device 100, along the bottom of attachment device 100, or upon any other appropriate portion thereof.

In some aspects, attachment device 100 may be configured to minimize the amount of potential allergens a user is exposed to while engaging in use of attachment device 100. This may be accomplished, by way of example and not limitation, by configuring the shape and/or size of body 102 and/or positioning it such that when attachment device 100 encounters one or more objects to be picked up, substantially all of the object(s) and any allergens they may include (such as dust, pollen, pet dander, and the like) get sucked into intake cavity 202 and do not get pushed or distributed into the air where they may come into contact with the user's body, particularly the user's nose, eyes, and/or mouth. This may be accomplished, by way of example and not limitation, by maximizing the suction force (or blowing force) into (or out of) intake cavity 202 and/or minimizing potential areas where objects and/or any associated allergens could escape from attachment device 100, such as gaps and/or openings within attachment device 100. Such gaps and/or openings may be minimized, for example, by having attachment device comprise as few components as possible, or by having the open face of inlet cavity 202 of body 102 of attachment device 100 be relatively close to the surface being vacuumed/cleaned (while still far enough away to prevent suction induced locking forces from locking attachment device 100 to the surface).

In addition to preventing the escape of allergens and objects, having attachment device 100 comprise as few components as possible may also help prevent breakage of attachment device 100, allow for relatively easy use and/or installation of attachment device 100, and/or allow attachment device 100 to comprise a relatively lightweight configuration. This is due at least partly because devices with many parts may be complicated to put together and/or use, and the locations at which different components connect are often the most vulnerable in terms of strength and durability. Additionally, having more parts ads weight to any device or apparatus. Therefore, in order to minimize the number of components used for a given attachment device 100, in some aspects, the only components that make up attachment device 100 may be body 102, attachment element 104, and rolling elements 116 (which may or may not be integrated with axle 210 and retaining channel 212, depending on their configuration), in addition to any fastening element(s) 108. In some additional aspects, more or fewer components may be used without departing from the spirit and scope of the present disclosure. In some further aspects, attachment device 100 comprises one single element, with every component integrated with every other component so as to form one single solid piece, with a possible exception being made for rolling component(s) 116, which may need to comprise one or more separate component(s) in order to allow for their movement.

Attachment device 100 and/or any component thereof may comprise any appropriate material(s), including but not limited to metals, plastics, other polymers, wood, glass, as well as any other similar material(s) as may be apparent to those skilled in the relevant art(s) after reading the description herein. In some aspects, attachment device 100 may comprise one or more parts that are currently available so as to reduce the various costs and/or complexities associated with manufacturing and/or repairing device 100 by reducing (if not eliminating) the amount of custom part creation needed. In some additional aspects, every component of attachment device 100 may comprise part(s) that are currently available.

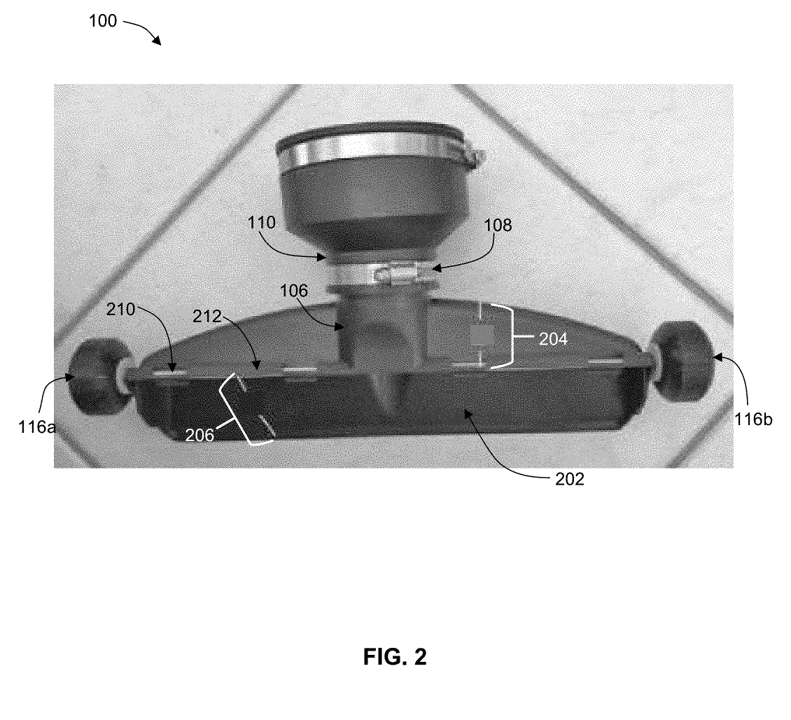

Referring now to FIG. 2, a rear view of exemplary attachment device 100 for use with exemplary suction apparatus 300, according to an aspect of the present disclosure, is shown.

In some aspects, attachment device 100 may be configured to substantially maintain or increase the amount of suction offered by a given inlet opening, such as nozzle 306, of exemplary suction apparatus 300. To achieve this, the cross sections of intake opening 106 of attachment device 100 and the associated connector portion 110 of attachment element 104 may be noticeably smaller than the cross sections of both attachment element 104 itself and the inlet opening of suction apparatus 300 while maintaining the same general shape (such as a circle) thereof. Having such a difference in size for the respective cross sections may cause the air pressure within intake opening 106 to be noticeably higher than the air pressure within attachment element 104 and the inlet opening of suction apparatus 300 since the air within intake opening 106 is more compressed. Being that air travels from areas of higher pressure to areas of lower pressure, the air and any objects and/or allergens within it inside intake opening 106 will be drawn into attachment element 104 and the inlet opening of suction apparatus 300 at a force that is supplemental to the suction force already supplied by suction apparatus 300. The void left by the air that leaves intake opening 106 is quickly filled by the air/objects/allergens within intake cavity 202, since that air is now at a higher pressure than the air within intake opening 106, such filling occurring again with a force that is supplemental to the suction force already supplied by suction apparatus 300. This high level of suction power may be particularly useful for larger and/or heavier objects, such as leaves, and particularly oak leaves. In some embodiments, attachment device 100 increases the suction power of suction apparatus 300 exponentially. The amount of increase may be controlled by adjusting the ratio between the difference in size between the cross sections of intake opening 106 of attachment device 100 and the associated connector portion 110 of attachment element 104 and the cross sections of both attachment element 104 itself and the inlet opening of suction apparatus 300.

By way of example and not limitation, in order to achieve the above-described configuration and operational performance, attachment element 104 (and hence the inlet opening of suction apparatus 300) may, in some embodiments, comprise a circular cross section with a diameter of approximately 4 inches (10.1600 cm) while intake opening 106 of device 100 may also comprise a circular cross section but may have a diameter of approximately 2 inches (5.0800 cm). Additionally, by way of example and not limitation, body 102 of attachment device 100 may comprise a depth 112 of approximately 4.25 inches (10.7950 cm) and a width 114 of approximately 14 inches (35.5600 cm). By way of further example and not limitation, body 102 of attachment device 100 may comprise a height 204 of approximately 2 inches (5.0800 cm) and a length 206 of approximately 3 inches (7.6200 cm). As will be appreciated by those skilled in the relevant art(s) after reading the description herein, these dimensions are merely for exemplary purposes only and in no way serve to limit the spirit and scope of the present disclosure.

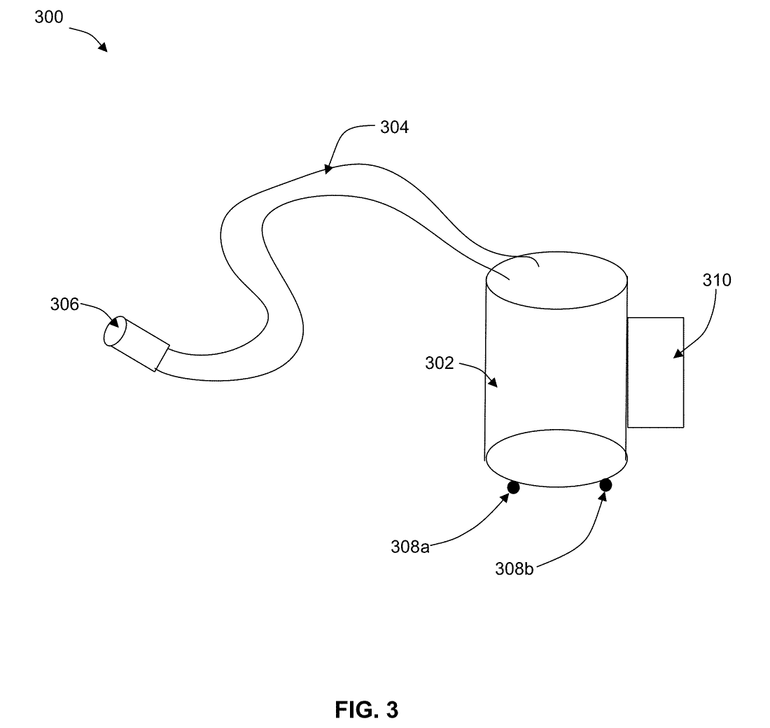

Referring now to FIG. 3, a perspective view of exemplary suction apparatus 300 usable with exemplary attachment device 100, according to an aspect of the present disclosure, is shown.

Exemplary suction apparatus 300 is representative and inclusive of a wide variety of different suction apparatus that may be used with attachment device 100 and that have inlet openings of a variety of shapes and sizes that attachment device 100 may be removably or permanently attached to and in no way serves to limit the spirit and scope of the present disclosure. Indeed, attachment device 100 may be used with a plethora of different suction apparatus 300 and other machines capable of producing suction and/or blowing forces, including but not limited to indoor and/or outdoor vacuums, industrial vacuums, shop vacuums (such as Shop-Vacs® available from the Shop-Vac Corporation of Williamsport, Pa.), lawn vacuums, yard vacuums, leaf vacuums, leaf blowers, air blowers, and any other similar apparatus or machines as may be apparent to those skilled in the relevant art(s) after reading the description herein. In order to facilitate attachment to different sizes and shapes of inlet openings, attachment element 104 of attachment device 100 may comprise a cross section that is adjustable in shape and/or size, or attachment device 100 may be used and/or integrated with a variety of different attachment elements 104 of various shapes and/or sizes.

In some aspects, exemplary suction apparatus 300 may comprise at least one reservoir 302 for capturing objects, such as leaves, debris, and allergens; at least one tubular hose 304 for brining captured objects to reservoir 304; at least one inlet opening in the form of nozzle 306 for receiving objects; at least one roller 308 (shown as rollers 308a-b in FIG. 3) for sliding suction apparatus 300 along a surface; and at least one motor 310 configured to provide a suction and/or blowing force at the mouth of nozzle 306 (or other inlet opening). By way of example and not limitation, roller(s) 308 may comprise wheels, casters, axles, rolling cylinders, rolling balls, as well as any similar element(s) as may be apparent to those skilled in the relevant art(s) after reading the description herein. Additionally, by way of example and not limitation, reservoir 302 may comprise any substantially hollow yet durable configuration capable of retaining objects, such as leaves and debris, brought in via nozzle 306. Reservoir 302 may comprise any one or more of a variety of materials, including but not limited to metals, plastics, canvas, other polymers, and the like.

Attachment device 100 may be used with suction apparatus 300 in order to pick up a wide variety of objects from a surface, including but not limited to leaves, dust, hair, trash, pine needles, sand, and dirt, as well as any of a plethora of other similar objects as may be apparent to those skilled in the relevant art(s) after reading the description herein.

While various aspects of the present disclosure have been described above, it should be understood that they have been presented by way of example and not limitation. It will be apparent to persons skilled in the relevant art(s) that various changes in form and detail can be made therein without departing from the spirit and scope of the present disclosure. Thus, the present disclosure should not be limited by any of the above described exemplary aspects, but should be defined only in accordance with the following claims and their equivalents.

In addition, it should be understood that the figures in the attachments, which highlight the structure, methodology, functionality, and advantages of the present disclosure, are presented for example purposes only. The present disclosure is sufficiently flexible and configurable, such that it may be implemented in ways other than that shown in the accompanying figures (e.g., implementation with apparatus and usages other than those mentioned herein). As will be appreciated by those skilled in the relevant art(s) after reading the description herein, certain features from different aspects of devices of the present disclosure may be combined to form yet new aspects of the present disclosure.

Further, the purpose of the foregoing Abstract is to enable the U.S. Patent and Trademark Office and the public generally and especially the scientists, engineers, and practitioners in the relevant art(s) who are not familiar with patent or legal terms or phraseology, to determine quickly from a cursory inspection the nature and essence of this technical disclosure. The Abstract is not intended to be limiting as to the scope of the present disclosure in any way.

What is claimed is:

1. An attachment device for a suction apparatus, the attachment device comprising:
a body comprising a length, a width, a height, a depth, at least one intake opening and an intake cavity, wherein the intake cavity comprises at least a portion of at least one of: the length, the width, the height, and the depth of the body, wherein the intake cavity further comprises an opening; and
at least one attachment element, wherein the at least one attachment element is configured to removably attach to an inlet opening associated with at least one suction apparatus;
wherein an amount of suction available at the at least one intake opening and the intake cavity is substantially similar to or greater than an amount of suction available at the inlet opening associated with the at least one suction apparatus; wherein the attachment device is configured to use suction provided by the at least one suction apparatus to remove at least one object from a surface.

2. The attachment device of claim 1, wherein the at least one attachment element comprises at least one connector portion configured to removably attach the at least one attachment element to the at least one intake opening of the body.

3. The attachment device of claim 1, wherein a cross section of the at least one attachment element is larger than a cross section of the at least intake opening of the body.

4. The attachment device of claim 3, wherein the cross section of the at least one attachment element and the cross section of the at least one intake opening are substantially circular.

5. The attachment device of claim 4, wherein the cross section of the at least one attachment element comprises a diameter of 10.1600 cm and the cross section of the at least one intake opening comprises a diameter of 5.0800 cm.

6. The attachment device of claim 1, wherein the body further comprises at least one rolling component configured to facilitate movement of the attachment device across the surface, wherein the surface comprises at least one of: an indoor surface and an outdoor surface.

7. The attachment device of claim 6, wherein the at least one rolling component comprises at least one of: a wheel, a caster, an axle, a rolling cylinder, and a rolling ball.

8. The attachment device of claim 7, wherein the at least one rolling component comprises a wheel, wherein the wheel comprises a rubber tire affixed to an outer circumference of the wheel.

9. The attachment device of claim 6, wherein the at least one rolling component is configured to maintain opening of the intake cavity of the body at a substantially consistent height above the surface.

10. The attachment device of claim 9, wherein the at least one rolling component is configured to maintain the opening of the intake cavity of the body at a height close enough to the surface to minimize a number of allergens that get disturbed by the attachment device and do not get sucked into the opening of the intake cavity.

11. The attachment device of claim 6, wherein the surface comprises at least one of: grass, concrete, tar, dirt, mud, sand, gravel, carpet, tile, linoleum, and wood.

12. The attachment device of claim 1, wherein the at least one object comprises at least one of: a leaf, dust, a strand of hair, a piece of trash, a pine needle, sand, and dirt.

13. The attachment device of claim 12, wherein the leaf comprises an oak leaf.

14. The attachment device of claim 1, wherein the at least one attachment element removably attaches to the inlet opening associated with the at least one suction apparatus via at least one fastening element.

15. The attachment device of claim 14, wherein the at least one fastening element comprises at least one of: a clamp, a clip, a pin, a bolt, a nut, a screw, a nail, a cable tie, a hook-and-loop fastener, an adhesive, a rivet, and a clasp.

16. The attachment device of claim 2, wherein the at least one connector portion removably attaches to the at least one intake opening via at least one fastening element.

17. The attachment device of claim 16, wherein the at least one fastening element comprises at least one of: a clamp, a clip, a pin, a bolt, a nut, a screw, a nail, a cable tie, a hook-and-loop fastener, an adhesive, a rivet, and a clasp

18. The attachment device of claim 1, wherein the length of the body is 7.6200 cm, the width of the body is 35.5600 cm, the height of the body is 5.0800 cm, and the depth of the body is 10.7950 cm.

19. The attachment device of claim 1, wherein the at least one suction apparatus comprises at least one of: an indoor vacuum, an outdoor vacuum, an industrial vacuum, a shop vacuum, a yard vacuum, a lawn vacuum, a leaf vacuum, a leaf blower, and an air blower.

20. An attachment device for a suction apparatus, the attachment device comprising:
a body comprising a length, a width, a height, a depth, at least one intake opening, at least one attachment element, and an intake cavity, wherein the at least one attachment element is configured to removably attach to an inlet opening associated with at least one suction apparatus, wherein the intake cavity comprises at least a portion of at least one of: the length, the width, the height, and the depth of the body, wherein the intake cavity further comprises an opening;
wherein an amount of suction available at the at least one intake opening and the opening of the intake cavity is substantially similar to or greater than an amount of suction available at the inlet opening associated with the at least one suction apparatus;
wherein the attachment device is configured to use suction provided by the at least one suction apparatus to remove at least one object from a surface.
